(19) United States
(12) Patent Application Publication
(10) Pub. No.: US 2010/0318618 A1
(43) Pub. Date: Dec. 16, 2010

(54) DEVELOPMENT TOOLS FOR TRANSITION-INDEPENDENT WEB FEATURES

(75) Inventors: CHRIS PARKER, SEATTLE, WA (US); STEVE GORDON, BELLEVUE, WA (US); OFFIR BAKSHITZ, REDMOND, WA (US); SIEBE TOLSMA, RICHMOND (CA); KYLE FARNUNG, REDMOND, WA (US); TERRY LENTZ, REDMOND, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/484,852

(22) Filed: Jun. 15, 2009

(51) Int. Cl. G06F 15/16; G06F 17/00

(52) U.S. Cl. 709/206; 715/234

(57) ABSTRACT

Computer-storage media, systems, and methods for facilitating development of web pages with cross-communicating tags are provided. The libraries and controls do not require a page transition or refresh operation to update information or instantiate features because the tags subscribe to a server for the information supplied to them. The update information can be requested by a first set of tags or pushed by a second set of tags. A package available online to developers includes development components for execution as part of a web page. These applications utilize APIs and a set of tags that are at least a portion of a markup language library. The tags are for initiating and executing web features, including instant messaging features. There is a developer interface to code the web page with the web application.

### BACKGROUND

The use of markup languages and tag libraries have become synonymous with the coding of web pages. Hypertext markup language (HTML), extensible markup language (XML), extensible hypertext markup language (XHTML) and Javascript™ are just a few examples of programming languages that use tags and scripts to enable certain features to be implemented on web pages. There are many tools that also allow developers to bypass many of the tedious aspects of the process, from developed libraries of tags that enable functions to developer interfaces that code the tags needed to create a page and remove the need for coding altogether. The development required is more intricate for some tags than others, depending on the functionality that is executed and underlying data that is retrieved by the tag. Some of the most complicated tags are used for real-time web applications.

### SUMMARY

Embodiments of the present invention relate to computer-storage media, systems, and methods for facilitating development of web pages with cross-communicating tags. The libraries and controls disclosed herein do not require a page transition or refresh operation to update information or instantiate features because the tags subscribe to a server for the information supplied to them. The information can be requested by the tags that require the information, or pushed by the tags that provide the data. A package available online to developers includes development tools for execution as part of a web page. These development tools utilize a set of APIs and tags that are at least a portion of a markup language library. The tags are for initiating and executing web features, including instant messaging features. The instant messaging features within the web page include initializing the application, manipulating user presence information, enabling an online conversation, accessing a contact list, and accessing a shared file. There is a developer interface to code the web page with the web application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is a flowchart of a method for developing web pages with instant messaging features enabled by cross-communicating tags;

FIG. 3 shows a high-level overview of the described embodiments of the present invention;

FIG. 4 and is an exemplary data flow for executing instant messaging controls and tags according to embodiments of the invention;

FIG. 5 is a flowchart of a method for executing instant messaging tags embedded in a web site according to embodiments of the invention; and

FIGS. 6 and 7 are exemplary graphical user interface screen depicting instant messaging controls on a web site in accordance with embodiments of the invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to methods, systems, and computer storage media having computer-executable instructions embodied thereon that, when executed, perform methods for performing a method of enabling cross-tag communication on a web page. A first tag in a set of tags instantiates instant messaging features on a web page. The first tag requests instant messaging information that is provided by a second tag in the set. The instant messaging information provided by the second tag is returned. The instant messaging feature instantiated by the first tag is executed. Without a subsequent page transition or refresh operation, the instant messaging information provided by the second tag is updated. This can be through subscription to an instant messaging server. The subscription can include the first tag requesting updates or the second tag pushing updates.

In another embodiment, methods, systems and computer storage media having computer-executable instructions embodied thereon for performing a method of developing web pages with instant messaging features enabled by cross-communicating tags. At a developer computing device a set of development components is requested from a server configured to provide tags that cross-communicate with an instant message platform. The developer components include at least one code tag that requests information from at least a second tag. The set of development components are received. The development components are included on a web page, so that when the development components are executed by a user of the web page, the information from the at least a second tag is updated by the instant message platform. This update occurs without any subsequent transition of the web page or refresh operation. Again, this can be through subscription to an instant messaging server utilizing requested or pushed updates between tags.

In another embodiment, methods, systems and computer storage media having computer-executable instructions embodied thereon for developing web pages enabled with cross-tag communication capabilities are provided. A web application executes as part of a web page. The web application utilizes at least of a portion a set of markup language tags for initiating and executing instant messaging features. The set of markup language tags codes instant messaging features within the web page. The instant messaging features include at least one of initializing the application, manipulating user presence information, enabling an online conversation, accessing a contact list, and accessing a shared file. A developer interface codes the web page with the web application and at least a portion of the set of markup language tags.

Having briefly described an overview of embodiments of the present invention, an exemplary operating environment suitable for implementing embodiments hereof is described below.

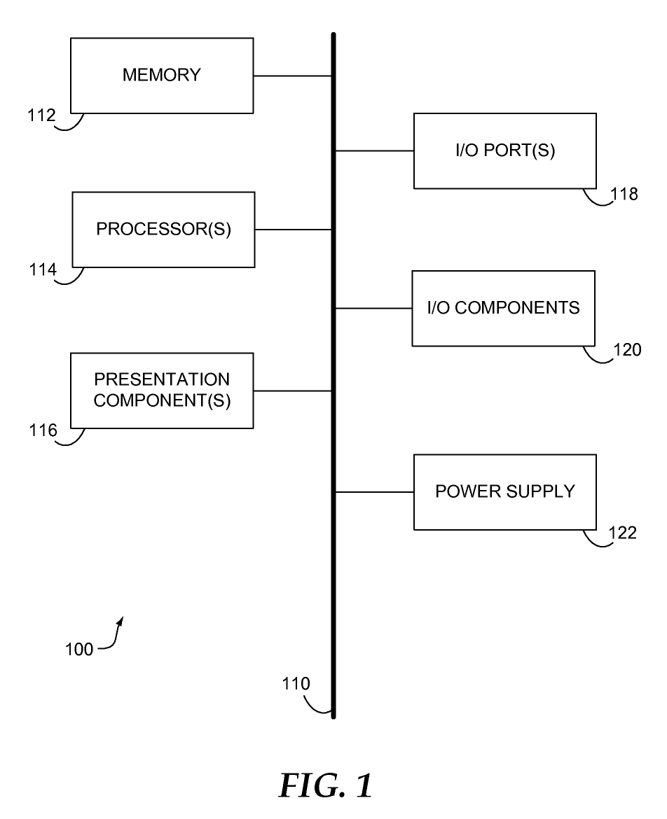

Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of invention embodiments. Neither should the computing environment 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would be more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

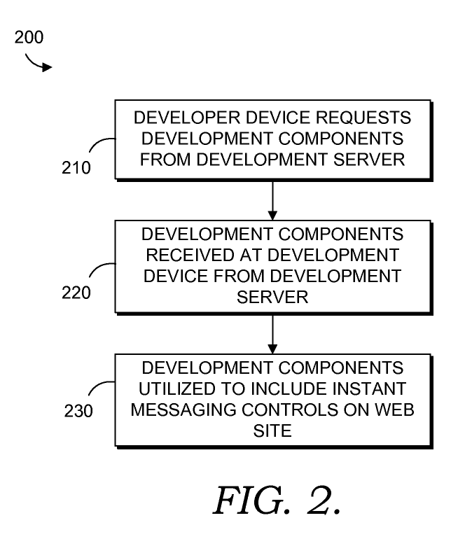

FIG. 2 is a flowchart of a method 200 for developing web pages with instant messaging features enabled by cross-communicating tags. At a step 210, a developer computing device requests one or more development components from a server configured to provide development components. At a step 220, the one or more development components are received at developer computing device.

A set of developer components include one or more application programming interfaces (APIs), tags, and libraries to allow a developer to embed instant messaging functionality into a web site. These APIs, tags and libraries instantiate the browser-accessible application to either the default specifications or those modified by the developer.

At step 230, a developer can use the above development components to develop web applications for web sites according to methods of the present invention. These methods use the cross-communicating tags to enhance the developer's ability to integrate real-time information in interactive functionality on the developed web site. The interactive functionality on the developed site includes instant messaging functions, such as instant messaging contact lists, instant messaging user presence information, and the like. In one embodiment, a web site developer can utilize downloaded APIs to include instant message functionality in a developed site. In another embodiment, a web site developer may utilize libraries to customize instant message functionality for a developed web site.

The development components enable a number of instant messaging features on a web site's pages. For the purposes of this disclosure, a web site maintained by a developer using the development tools is a developed site. As discussed above, exemplary instant messaging functionality that may be included in a developed web site includes a contact list, an instant messaging (IM) communication window, user presence information in the IM context and sharing of files in an IM window. The provider of the development components may be a specific IM platform. Exemplary IM platforms include, but are not limited to, stand-alone IM platforms such as Windows Live Messenger, AOL instant messenger, and Yahoo! Messenger. Use of the development tools allows the IM platform to be communicatively coupled with the developed web site's IM functionality.

The development tools described herein allow developers to link content from a web site directly into individual users' updates regarding their IM interface personal messages. These are the messages seen by the users' contacts and connections while they are online or offline. Again, this can be shared by both an IM platform and the web-integrated IM applications on the developed site. For instance, an IM platform may have a messaging box that appears on the user's desktop. The developed site may have an IM area that is simply another browser window opened in whatever browser the user has chosen for visiting the site. The personal message may be seen by users of both the IM platform and the browser-enabled IM application.

Profile data, such as a display name and profile picture, from an IM platform can also be used to personalize and customize user profile data on the developed site. By passing authentication information along to the developed site from the IM platform, developers can allow users to access and comment on a site, such as a blog. The sharing of login authentication with the developed site's IM application also gives users the ability to invite contacts in the IM platform to chat or play a game together in real-time.

A library of elements that subscribes to a messaging server of the IM platform is available for developers and can enable a number of features within a web environment. This can include requesting updated information by a rest set of tags or pushing updated information from a second set of tags. For instance, a portion of the available UI controls facilitate initialization aspects of a user's online experience. Those elements falling in this set include a control for the overall enablement of IM controls through application initialization. This category of tagged features also includes initialization of individual application states, such as a user login feature for a messaging application. As an example, login features can be implemented to log in a user because of prompts and authentication information received for the user through the developed web site. Alternatively, if a user is already logged into a messaging application, the authentication information can simply be passed along to the developed web site to reflect log in state for that site's instant messaging as well.

A collection of UI element tags described herein can also manipulate the user's “presence” within an instant messaging system. As examples, these tags include user profile, name, display picture, log in status and personal messages for the system. The name displayed need not be the username used to log in, but can be associated with a user-friendly name selected by the user. For example, the user's first name can be shown in lieu of a complicated user name. The user can select a display picture or graphic to associate with their use of the IM system. Likewise, a personal message selected by the user can be entered and changed frequently according to usage of tags falling within this collection.

Two types of contacts controls are available with the described embodiments of the present invention. The first type include a contact list tag, as well as tags that control adding to a user's contact list and picking a contact within the user's current contact list. These are all specific to the contact list maintained by the user, i.e. functions of an online address book. The second type of contact control is the application contact control, which is application specific but not specific to the user. The user can see other members that the developed site makes available for their viewing, such as online members or members of a certain user group. Thus, the user of the developed site may have two types of contacts visible to them in separate lists—those that are included in their contacts, such as networked members of a social networking site, and those that are currently utilizing a particular site's IM functionality. On the same social networking site, the user may have the opportunity to see all users utilizing the IM platform, or those that have granted access to be visible to other users.

The disclosed embodiments also include high-level conversation and conditional flow controls. The high-level conversation tags enable a developer to provide functionality to manipulate a conversation, such as a text-input area. This is the same tag or group of tags that allow for message history information to be displayed or available. One or more conversation list tags impart the functionality to show and manipulate a list of current conversations. The conditional flow controls include complementary tags. An “if” tag can display content when a certain condition is met, while the “else” tag is used in conjunction with the if tag. Intuitively, the else tag imparts functionality when the if condition is not met.

TABLE 1
Exemplary psuedocode

```
<html xmlns:msgr=””>
<head>
  <script src=”Link to UI Control script source”></script>
</head>
<body>
  <msgr:app></msgr:app> <!-initialization tag. Different attributes, detailing how the
app should run ->
  <msgr:status cid=”$user”></msgr:status> <!-display status icon for the logged in user
->
  <msgr:profile cid=”12345”></msgr:profile> <!-high level profile control that shows
name, picture, status, personal message. Showing it for the user with the ID 12345 ->
  <msgr:contact-list></msgr:contact-list> <!-display a contact list ->
  <msgr:conversation-list></msgr:conversation-list> <!-display a conversation list ->
</body>
</html>
```

One aspect of the described tags and controls that eases a developer's task is the ability of the tags to provide necessary data across tags. For instance, there are tags for the user's contact list described above that implement contact-list functionality. However, part of that functionality can involve an action that instantiates features enabled by a second tag. For instance, a double-click by a user on the contact list could automatically open a conversation window. This requires a contact list tag to invoke functionality made possible by a high-level conversation tag and to provide that second tag with portions of underlying data (i.e., the user, the contact, etc.). This could be seen in the table below by the operation of the contact-list tag and the conversation-list tag. Actions that use the former tag can request data provided by the latter tag. By providing libraries that enable this cross-tag communication and freeing the developer from the need to code all aspects of the application functionality, the site developer is free to customize his or her site in other ways. For example, the specific look and feel of a conversation text-box may be more easily made to match the developed site's overall look if there is no need to develop the functions carried out by the IM application or the contact list functionality.

Another aspect of these controls and libraries that enhances the user's experience is the real-time update of underlying data to these tags. Because embodiments of the invention include tags that subscribe to the messaging server of an IM platform to receive the necessary information, these tags do not require a page refresh or transition in order to show changes to the associated data. Instead, the underlying data can be provided in response to a request by a first set of tags, or because of a push of that data by the second set of tags to the first set of tags. Thus, a user may frequently change a personal message that other users see, and the modifications made are available in near-real-time fashion. The tag or list of tags used to show a user's personal message may receive its information from a profile tag. Once the profile data has changed, that is the personal message has been updated, the tag requesting this information will automatically receive the new information on the subscription request or push. Similarly, a change in a user's picture or graphic would be available in near real-time, as would any other piece of information supplied by the user and granted access to the developed site.

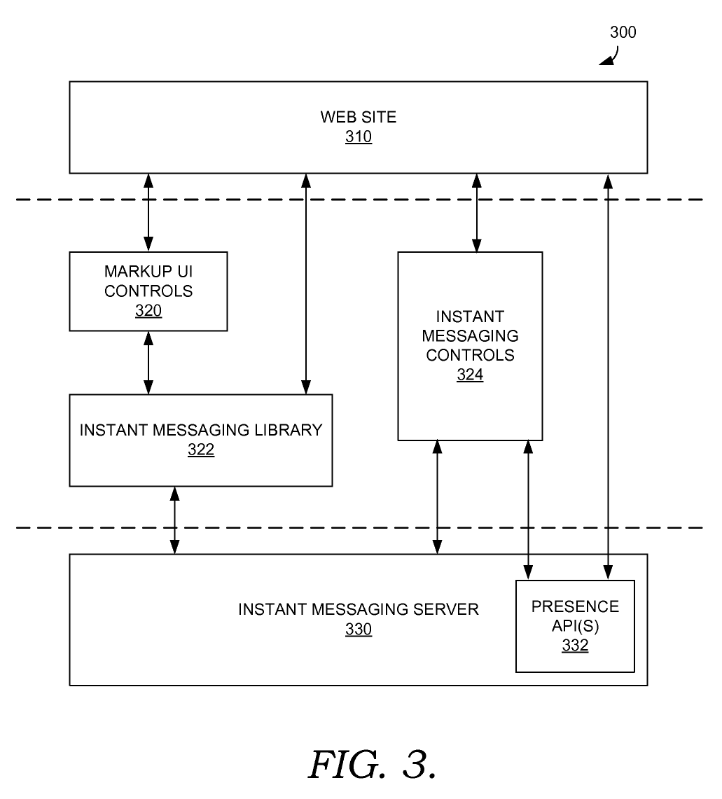

Turning now to FIG. 3, a high-level overview 300 of embodiments of the present invention is shown. The figure is divided into three areas to delineate three phases of the interaction that is contemplated by the present disclosure. At the top of the figure is an application web site 310, which is shown belonging to one area of the figure. This is the developed web site, on which a web application may reside and be invoked. There is no limitation as to what type of web site can implement the described functionality, as it could be a social-networking site, a news site, a blog, a genre-specific information site, a retail site, or any of thousands of other exemplary web sites. Application web site 310 is in communication with markup controls 320, instant messaging controls 324, and presence APIs 332, which are described in further detail above and below.

Markup controls 320, an instant messaging library 322, and instant messaging controls 324 are included in a second area of the figure, which represents the virtual space where the application site and the IM platform interact on an application level. Markup controls 320 can be similar to those described above and can be implemented through HTML, XML, and XHTML, or any other suitable markup language. Again, these controls can be supplied by the IM platform or custom created by those responsible for the developed site. Markup controls 320 use IM library 322 as an intermediary in communicating with IM service 330. IM library 322 can be compiled scripts, such as those created with Javascript. The third component of the interface area is IM control 324, which may or may not be used on the developed web site. Again, control 324 can enable communication between the developed site and the IM platform directly, without requiring controls 320 or library 322. It is also contemplated that presence APIs residing in the third area of the diagram can communicate with control 324.

The third area noted on the lower portion of the FIG. 3 includes an instant messaging service 330, such as an IM platform, that includes presence APIs 332 as a component. Again, this area is separated to show that it is not part of the developed site or virtual area of the interface between the two. Therefore, presence APIs 332 can communicate with IM control 324 in the interface area or directly with the web application at developed web site 310. IM platform 330 can also communicate with IM controls 324 according to methods that do not involve presence APIs 332, such as by those required for actually enabling conversations.

As shown in FIG. 3, developed web site 310 has several avenues through which the tags used for real-time features subscribe back to IM platform 330. Thus, the tags that relay the data to visitors on the site can flexibly provide the functionality the developer desires to include. This can be through the controls 320 by way of library 322, via IM controls 324, and through presence APIs 332 (directly or through controls 324).

As described herein, in one embodiment the web content the developed site communicates directly with the UI controls 320. The UI controls 320 are in a markup language that requires no intermediary form with the web application. However, in many instances, the UI controls 320 do not communicate directly with the IM platform 330, but through the underlying IM library 322.

The underlying IM library 322 can be in a variety of languages and is one or more client-side libraries, which will be referred to in the singular for simplicity sake. The library 322 can either communicate with the previously mentioned markup-language UI controls 330 or directly with the web application on the developed web site. As an example, this can be a library programmed in C# and compiled into a Javascript library. In such an instance, applications could be written in either C# or Javascript, in part determining whether the library communicates directly with the application or not. The library 322 provides APIs that expose the IM functionality, such as those described above. The ability of the library 322 to directly communicate also enables integration of the IM functionality into the application to a greater degree than can be accomplished with only use of the UI controls 320 alone. Thus, a text area that has the look and feel of the IM platform's stand-alone desktop messaging application can be possible through direct integration.

IM controls 320 can be included on developed web pages to provide instant messaging integration. These controls 320 enable delegated authentication, i.e., authentication by the IM platform server, as well as anonymous instant messaging. In addition, these controls 320 enable developed sites to show available users of the IM platform who allow their presence to be so shared. It also allows visitors of the developed site to engage in IM conversations with them. A developed site can invite users to share their presence information and exchange messages with other visitors to the site. By hosting IM controls, the developed site can enable transmission of instant messages to IM platform users directly from a web browser without requiring the installation of a IM platform desktop client by those not on the IM platform.

For example, a social networking site can invite its users to share their IM platform presence on user profile pages. Similarly, the author of a blog could utilize the IM controls to invite his or her readers to discuss a particular topic through their shared presence with the developed site. For a developed site to show an IM platform user's presence, the user must give permission to share presence and receive messages. Once permission is granted and a developed site places the IM control for a particular web site user on a page, a user navigating to the page has the ability to see the control and therefore the IM platform user. The user can send messages to the IM platform user through these IM controls. The developed site invites the IM platform user to share presence and obtain the proprietary identification. To invite the user to give permission to share presence and receive messages from a specific site, the developed site would then use delegated authentication from the IM platform site.

Presence application programming interfaces (APIs) allow users to indicate their IM presence and allow developed site visitors to send messages through the IM platform when the user is online. The presence APIs can be used in tandem with the IM controls to provide integration or can be used directly through communication with the web application. In one embodiment, the presence APIs are based on hypertext transfer protocol, and returned a user's presence through JavaScript Object Notation (JSON). The presence APIs are primarily used in conjunction with the IM platform controls, but need not be.

During the development process, the development components described above are requested from one or more servers. Web sites can be provided by the same entity that provides the development components, but need not be. In fact, with the proliferation of web site servers, it is actually likely that there will be numerous web site servers not associated with the underlying libraries and controls. The development tools and libraries may be associated with a particular IM platform. However, this is also not a requirement. This is evident in the increasing ability to message across different IM platforms through web-browsing implementations. Embodiments of the present invention contemplate situations when the control and library content can be separately supplied from the IM platform or together.

Because of the possibility that such requests and responses for a development scheme will be provided by different sources, description will be given with different servers to receive and send requests and responses. However, this again should not be construed as a limitation to the present disclosure. Instead, it is considered wholly possible within the scope of this disclosure that the web sites, IM development tools, and IM platform could all be produced by the same source. Therefore, all three could be physically or logically located at a single site or on a single computing device. The conglomeration of two of the three sources is also within the scope of the present disclosure, as either the web site and development tools, or the tools and the IM platform can be provided by different or by identical sources.

The necessary development components are provided to the developer of the developed site. A specific order for delivery, however, is not needed, as an adept developer may be aware of the APIs and libraries required for download by a web application prior to actually downloading the application.

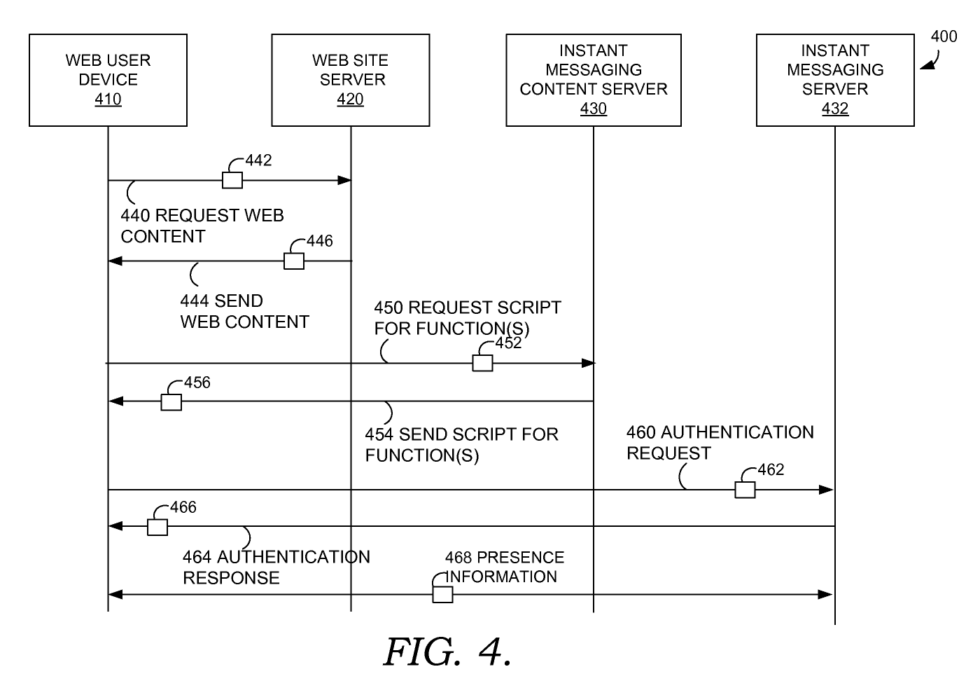

FIG. 4 is now described herein that outlines an exemplary data flow 400 for executing instant messaging controls and tags according to embodiments of the invention. The dataflow involves a web user device 410, which can be similar to a computing device described with respect to FIG. 1. In one example, web user device 410 is communicatively coupled with three servers that provide various aspects of embodiments of the invention. A web application provider server 420, IM content server 430, and IM platform 432 all provide functionality and data to web user computing device 410.

At step 440 a request 442 is sent from web user computing device 410 to web application provider 420. At step 444, web application provider provides the web content to device 410. For example, web user may request a particular web page. Web application provider 420 returns the web content and associated controls and tags for the web page. At step 450, a request 452 is made by the user device 410 to IM content server 430 for the scripts and tags of the web content returned by web application provider 420. A response 456 is returned from content server 430 to device 410 at step 454.

At step 460, an authentication request 462 is sent from device 410 to an IM platform server 432. A response 466 is returned from the IM platform server 432 to device 410 so that the user may be authenticated to the IM platform server 432. At step 464, the authentication response 464 authenticating the user is sent from IM platform server 432 to web user device 410. Once the user device 410 utilizing a developed web site with embedded IM platform functionality is in communication with the IM platform server 432, changes in the user's status, personal messages and the like are reflected in a near real-time manner through subscription to underlying data 468 from the IM platform server 432 that is in communication with web user device 410 as discussed in more detail below.

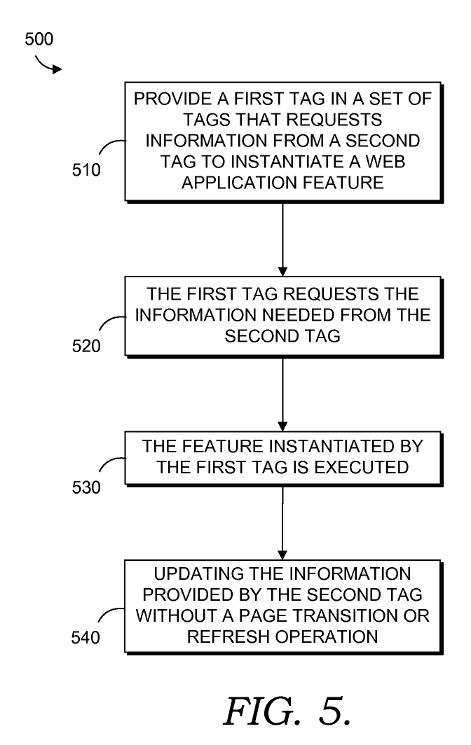

Turning now to FIG. 5, a flowchart representing a method 500 of enabling cross-tag communication on a web page with an IM platform is shown. At a step 510, a first tag in a set of tags is provided to instantiate features on a web page. The set of tags can be for an IM platform. The set of tags can be coded in a markup language, such as HTML, Javascript, XML, or XHTML.

The features can be those associated with initializing a web application, manipulating user presence information, enabling an online conversation, accessing a contact list, and accessing a shared file. For example, the features on the web page can be a minimum set that is necessary for integrating features for an IM platform. For exemplary purposes, the instant messaging features can be entirely web-enabled, thus not requiring a stand-alone IM platform. User presence information can include a user display name, a user display picture, a user display graphic, a user status, user profile information or a personal message specified by the user. The shared file can be a picture, a graphic, an audio file, a video file, or any other type of file that the user may care to share with another user with whom he or she is communicating. The list of features should not be construed as exhaustive, but merely lists some of the functionality that a developer may find useful to incorporate into a web site.

At a step 520, the information provided by the second tag is requested by the first tag. An example could be the request completed when a contact list is double-clicked by the user, which opens an instant messaging conversation. The contact list tag would request the necessary information from a conversation tag in order to instantiate the feature, including any other information needed from still other tags. Examples could include a user-friendly name from profile tags or status information from presence tags. At a step 530, the feature instantiated by the first tag is executed.

Without a subsequent page transition or refresh operation, the information provided by the second tag is updated at a step 540. Updating occurs through subscription to an instant messaging server by the web application. This can be through a request by the first tag. Alternatively, this can be by the second tag pushing the updates. Thus, the first tag continually receives updated information regardless of navigation to the page or the refresh rate of the page. Changes to the user's status, personal messages, and the like would be reflected in a near-real-time manner through this subscription to the underlying data of the IM platform.

In order to provide clarity to the foregoing descriptions, an example will be given of the development and use of a web site with the aforementioned features. The exemplary web site could be one served by a sports news service that also offers “fantasy sports” leagues. With these leagues, visitors to the sports site can draft players for a given sport, baseball in the exemplary case, and compete against others in their league. Statistical performances by the players are then tracked, the league members may acquire new players, drop players, and trade with other members of the league. As part of this service, the sports site may wish to offer league members the ability to select players during a live draft, as well as using instant messaging during the course of the particular season.

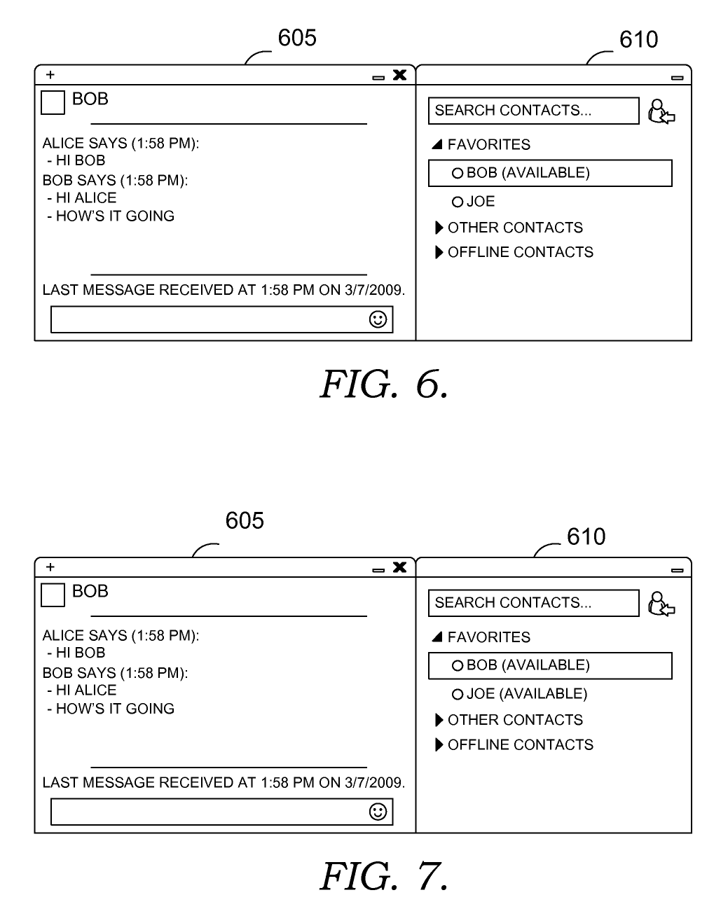

In this example, developers for the sports site to partner with a provider of IM platforms without creating stand-alone IM functionalities for their site's users. Thus, an IM platform provides the web-enabled IM capability for the sports site. The IM platform allows users to share presence information with the sports site. With reference to FIGS. 6 and 7, in this example, Bob, Alice and Joe are members of a fantasy sports league. When Alice opens the fantasy league web site, controls are executed for instant messaging function for an IM platform. A web developer has embedded IM functionality for an platform in the fantasy sports web site.

A login box for the IM functionality for the IM platform on the fantasy sports web side is provided to Alice. Alice logs onto the platform through the web-enabled IM functionality on the web site. An associated instant messaging box 605 and contact list 610 are displayed 610 to Alice. As can be seen in FIG. 6, when Alice begins an IM conversation with Bob, one of her IM contacts, Joe, is not available. During Alice's IM conversation with Bob, Joe becomes available. As can be seen in FIG. 7, based on a tag that was embedded in the web site by the developer, Joe's presence information is automatically updated by the IM platform in Alice's web-enabled contact list without subsequent page transition or refresh operation by Alice. Again this can be by request for the information, or by pushing the information.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-storage media having computer-executable instructions embodied thereon for performing a method of enabling cross-tag communication on a web page, the method comprising:
providing a first tag in a set of tags to instantiate instant messaging features on a web page, wherein the first tag requests instant messaging information that is provided by a second tag in the set;
providing the instant messaging information requested from the second tag;
executing the instant messaging feature instantiated by the first tag;
and
without a subsequent page transition or refresh operation, updating the instant messaging information requested from the second tag.

2. The media of claim 1, wherein updating occurs through subscription to an IM platform server by the web page.

3. The media of claim 2, wherein subscription to an IM platform server by the web page results the first tag requesting the information from the second tag, or the second tag pushing the information to the first tag.

4. The media of claim 3, wherein the set of tags are at least a portion of a web page.

5. The media of claim 4, wherein the set of tags are coded in a markup language.

6. The media of claim 5, wherein the markup language is at least one of Javascript, extensible markup language (XML), hypertext markup language (HTML), and extensible hypertext markup language (XHTML).

7. The media of claim 3, wherein the features on a web page are instant messaging features.

8. The media of claim 3, wherein the instant messaging features are entirely web-enabled and do not require a stand-alone instant messaging application.

9. The media of claim 7, wherein at least one of features is associated with initializing an application, manipulating user presence information, enabling an online conversation, and accessing a contact list.

10. The media of claim 9, wherein instant messaging features are at least one of a user display name, a user display picture, a user display graphic, a user status, user profile information or a personal message specified by the user.

11. One or more computer-storage media having computer-executable instructions embodied thereon for performing a method of developing web pages with instant messaging features enabled by cross-communicating tags, the method comprising:
at a developer computing device, requesting a set of development components from a server configured to provide tags that cross-communicate with an instant message platform, wherein the developer components include at least one code tag that requests information from at least a second tag;
receiving the set of development components;
including the development components on a web page, such that when the development components are executed by a user of the web page the information from the at least a second tag is updated by the instant message platform without any subsequent transition of the web page or refresh operation.

12. The media of claim 11, wherein the one or more development components enable instant messaging features.

13. The media of claim 12, wherein the instant messaging features are entirely web-enabled and do not require a stand-alone instant messaging application.

14. The media of claim 13, wherein the development components are encoded from a markup language that is selected from a group of Javascript, extensible markup language (XML), hypertext markup language (HTML), and extensible hypertext markup language (XHTML).

15. The media of claim 14, wherein the development components include one or more of a user interface (UI) control, an instant messaging control, a presence application programming interface (API), and an instant messaging library.

16. The media of claim 15, wherein the UI control includes one or more controls for initializing an application, manipulating user presence information, enabling an online conversation, and accessing a contact list.

17. The media of claim 16 wherein the information provided to the first tag is automatically provided by the second tag without a page transition or refresh operation.

18. The media of claim 17, wherein the automatically provided information is provided to the first tag through subscription to an IM platform server resulting in the first tag requesting the information from the second tag, or the second tag pushing the information to the first tag.

19. A computer system embodied on one or more computer-storage media having computer-executable instructions embodied thereon for developing web pages enabled with cross-tag communication capabilities, the system comprising:
a web application for execution as part of a web page, wherein the web application utilizes at least a portion a set of markup language tags for initiating and executing instant messaging features;
the set of markup language tags for coding instant messaging features within the web page, wherein the instant messaging features include at least one of initializing the application, manipulating user presence information, enabling an online conversation, accessing a contact list, and accessing a shared file; and
a developer interface to code the web page with the web application and the at least a portion of the set of markup language tags.

20. The system of claim 19, wherein the instant messaging features are entirely web-enabled and do not require a stand-alone instant messaging application.
